(19) United States
(12) Patent Application Publication
(10) Pub. No.: US 2023/0399151 A1
(43) Pub. Date: Dec. 14, 2023

(54) PORTABLE BEVERAGE CONTAINER WITH SLEEVE

(71) Applicant: Become Current PBC, Scituate, MA (US)

(72) Inventors: Alexander Stanfell Boone, Cardiff By The Sea, CA (US); Richard Henry Cook, Scituate, MA (US); Travis Jay Rosbach, Bend, OR (US)

(73) Assignee: Become Current PBC, Scituate, MA (US)

(21) Appl. No.: 18/334,295

(22) Filed: Jun. 13, 2023

Related U.S. Application Data
(60) Provisional application No. 63/366,326, filed on Jun. 13, 2022.

(51) Int. Cl. B65D 43/02; B65D 81/38

(52) U.S. Cl. CPC B65D 43/0225; B65D 81/3876

(57) ABSTRACT

A beverage container. The container includes an inner canister. The inner cannister includes a base coupled to a wall. The wall includes a first wall region and a second wall region adjoining the first wall region. The base and the wall forms an interior region for containing a beverage. The container also includes a lid configured to be removably coupled to the inner canister via a screw mechanism. The lid includes one or more lid magnets. The system also includes an outer sleeve configured to be removably coupled to the inner canister. The outer sleeve includes one or more sleeve magnets. The lids magnets are configured to magnetically couple with the sleeve magnets such that the lid is magnetically stuck to the sleeve and appears to levitate adjacent to the sleeve when the lid magnets come within close proximity to the sleeve magnets.

### CROSS-REFERENCE TO RELATED APPLICATIONS

This application claims priority to Provisional U.S. Patent Application No. 63/366,326, titled “PORTABLE BEVERAGE CONTAINER WITH SLEEVE,” (TNGOP004P) filed on Jun. 13, 2022, by Alexander Boone et al., which is incorporated herein by reference in its entirety and for all purposes.

### TECHNICAL FIELD

The present disclosure relates to beverage systems, and specifically to beverage container systems.

### BACKGROUND

Although the human body is composed of 60% water, most people do not get enough water on a daily basis. These days, people are so busy that they do not even have time to properly hydrate. Instead of water, people often drink other beverages as replacements. For example, beverages such as tea and coffee have become essential for most working adults. In fact, tea is the second most widely consumed beverage in the world, after water. Similarly, coffee is also a ubiquitously enjoyed beverage and is the third most widely beverage in the world after tea. Regardless of which beverage a person chooses to consume, people need a container that can facilitate beverage consumption within a lifestyle “on the go,” which is becoming increasingly more popular. Common beverage containers suffer from many drawbacks that hinder a lifestyle “on the go.” For example, most beverage containers require two hands to open and close a lid, which can be cumbersome if the person is in a hurry or multi-tasking. In addition, most beverage containers require a person to take off a lid of the container during refills, which requires the person to place the lid down on a surface or hold the lid in their hand during a refill. Thus, there is a need for an improved beverage container that fits within a lifestyle “on the go.”

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

Aspects of the present disclosure relate to a beverage container and a system. The system includes an inner canister. The inner cannister includes a base coupled to a wall. The wall includes a first wall region and a second wall region adjoining the first wall region. The base and the wall forms an interior region for containing a beverage. The system also includes a lid configured to be removably coupled to the inner canister via a screw mechanism. The lid includes one or more lid magnets. The system also includes an outer sleeve configured to be removably coupled to the inner canister. The outer sleeve includes one or more sleeve magnets. The lids magnets are configured to magnetically couple with the sleeve magnets such that the lid is magnetically stuck to the sleeve and appears to levitate adjacent to the sleeve when the lid magnets come within close proximity to the sleeve magnets.

In some embodiments, the magnets are curved shaped to provide uniform magnetic fields. In some embodiments, the lid magnets are configured such that the lid magnets will only stick to the sleeve magnets when the lid is upside down. In some embodiments, the screw mechanism is a wave pattern. In some embodiments, the screw mechanism includes magnetic guides. In some embodiments, the lid includes a horizontal push button to horizontally open a lid opening cover. In some embodiments, the lid includes a processor for implementing various smart functions. In some embodiments, the sleeve includes a processor for implementing various smart functions. In some embodiments, the inner canister includes a double vacuum seal between the first wall region and the second wall region. In some embodiments, the inner canister can be removed from the sleeve via a single push button release mechanism

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

The disclosure may best be understood by reference to the following description taken in conjunction with the accompanying drawings, which illustrate particular embodiments of the present disclosure. In the description that follows, like parts are marked throughout the specification and drawings with the same numerals, respectively. The drawing figures are not necessarily drawn to scale and certain figures may be shown in exaggerated or generalized form in the interest of clarity and conciseness.

FIGS. 1A-1D show examples of a beverage container, in accordance with embodiments of the present disclosure.

FIGS. 2A-2B show a close up of a vertical slice view of a beverage container, in accordance with embodiments of the present disclosure.

FIGS. 3A-3D show examples of an inner ring release mechanism, in accordance with embodiments of the present disclosure.

FIGS. 4A-4B show examples of magnetic coupling between the lid and sleeve, in accordance with embodiments of the present disclosure.

FIGS. 5A-5C show various magnetic configurations, in accordance with embodiments of the present disclosure.

FIG. 6 shows an example threading pattern, in accordance with embodiments of the present disclosure.

FIGS. 7A-7B show a lid coupling with magnet guides, in accordance with embodiments of the present disclosure.

FIG. 8 is a block diagram showing different electronic smart features of a bottle, in accordance with embodiments of the present disclosure.

FIG. 9 shows one example of an electronics system, in accordance with embodiments of the present disclosure.

### DETAILED DESCRIPTION

Reference will now be made in detail to some specific examples of the disclosure including the best modes contemplated by the inventors for carrying out the disclosure. Examples of these specific embodiments are illustrated in the accompanying drawings. While the disclosure is described in conjunction with these specific embodiments, it will be understood that it is not intended to limit the disclosure to the described embodiments. On the contrary, it is intended to cover alternatives, modifications, and equivalents as may be included within the spirit and scope of the disclosure as defined by the appended claims.

For example, the techniques of the present disclosure will be described in the context of beverage systems and containers. However, it should be noted that the techniques of the present disclosure apply to a wide variety of systems and containers. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, smart beverage containers or systems may use a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, while a push button may be connected to lid opening cover, it will be appreciated that a variety of component parts such as springs and latches may reside in the lid between the push button and the lid opening cover. As another example, a processor may be connected to memory in smart lids, but it will be appreciated that a variety of bridges and controllers may reside between the processor and memory. Consequently, a connection does not necessarily mean a direct, unimpeded connection unless otherwise noted.

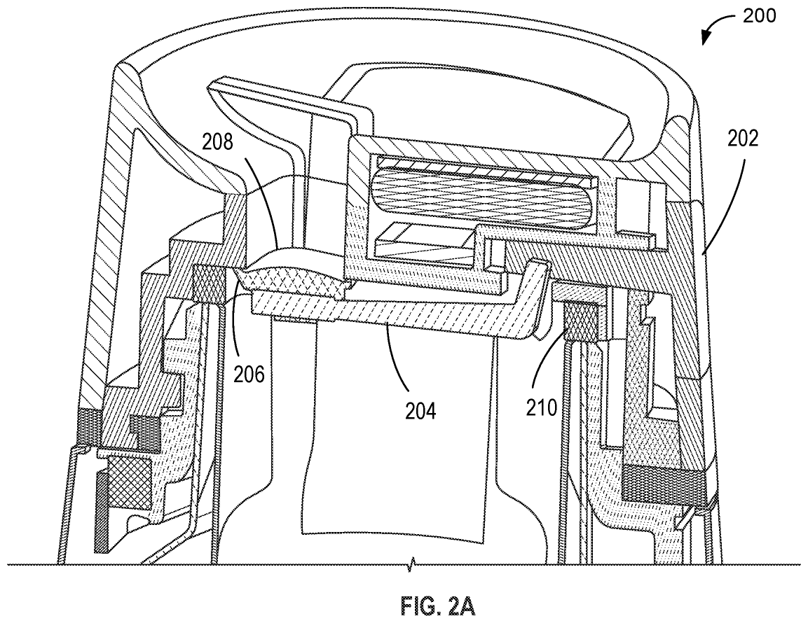

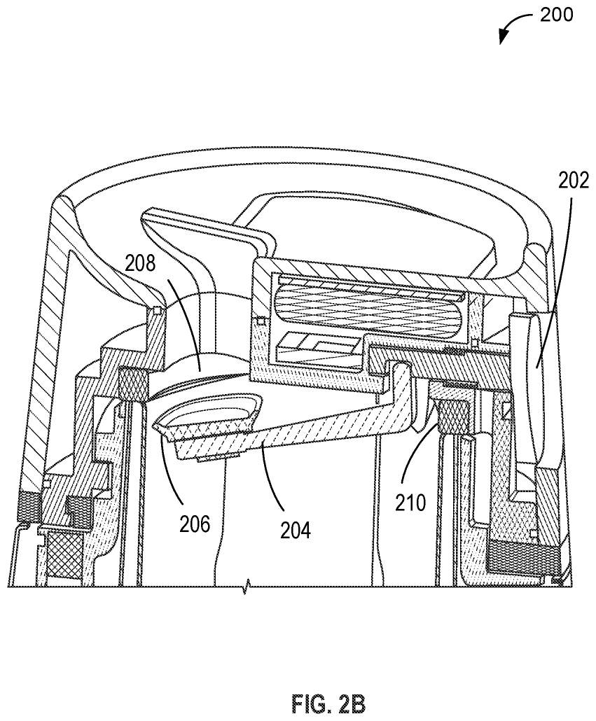

As previously mentioned, a lifestyle “on the go” requires ease and convenience when it comes to consuming beverages. These problems are experienced by active people on a day to day basis. The techniques and mechanisms disclosed herein present a solution for drinking, refilling, cleaning, and long term use, all in a system that works together. For example, according to some embodiments, as shown in FIGS. 2A-2B, the lid includes a push button mechanism 202 that facilitates drinking a beverage in a fully closed container with only one hand. In some embodiments, the user pushes a button, a spring actuates, and an opening in the lid is uncovered. In some embodiments, a horizontal cover sliding mechanism uncovers the opening. However, various other space efficient embodiments can also be used. In some embodiments, the opening only stays open as long as the user is holding on to the button. In such embodiments, the spring mechanism pushes the horizontal sliding mechanism back into its original position once the user lets go of the button. Thus, the user can easily drink from a completely closed, spill proof, beverage container with only one hand, which is ideal for people on the move.

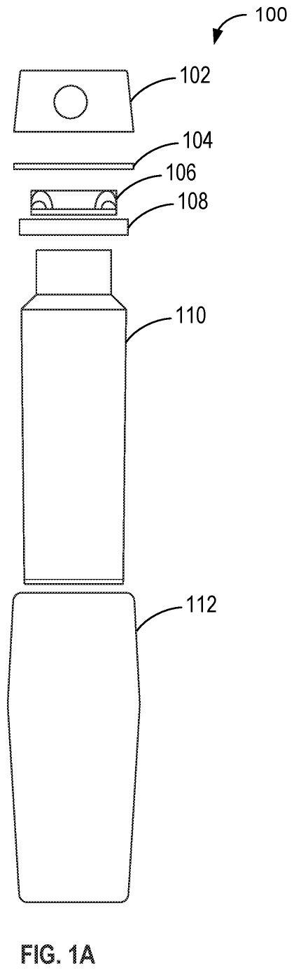

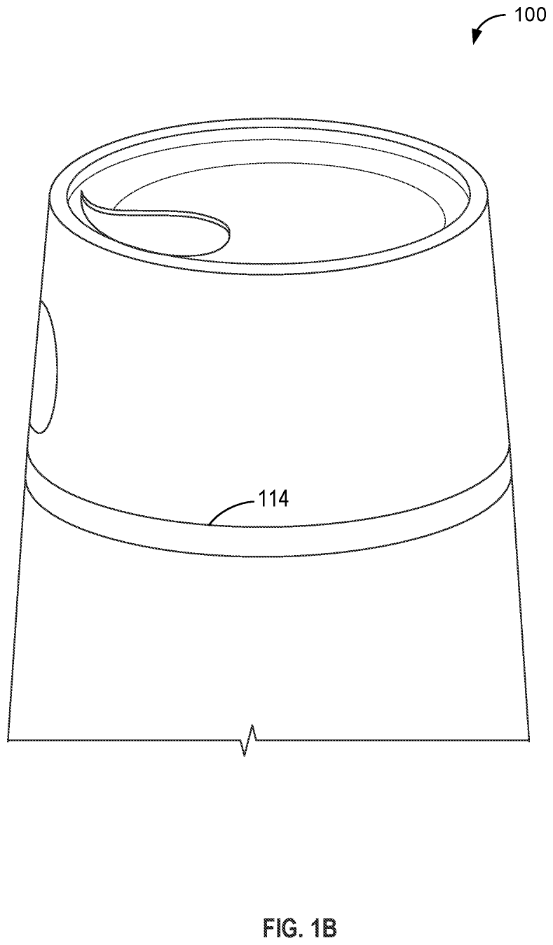

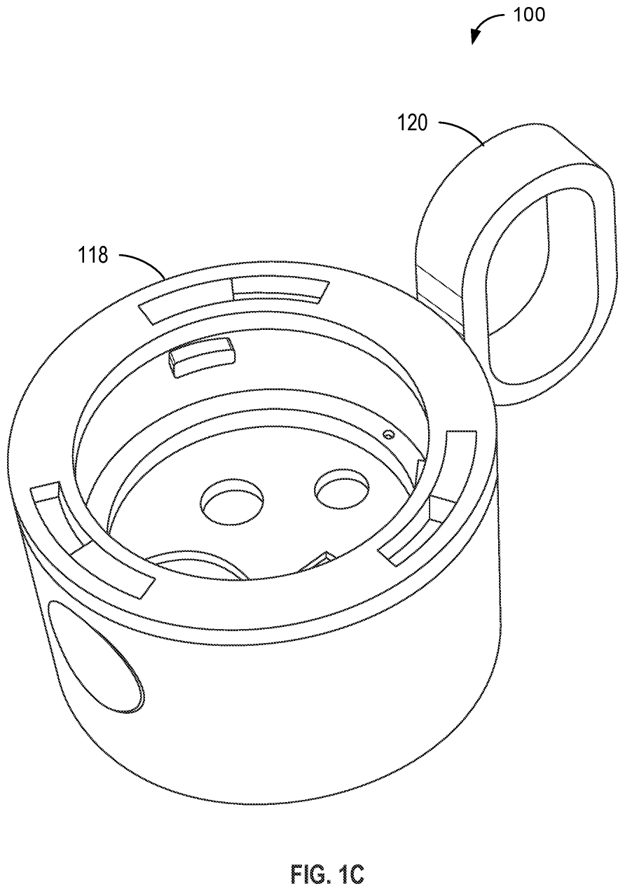

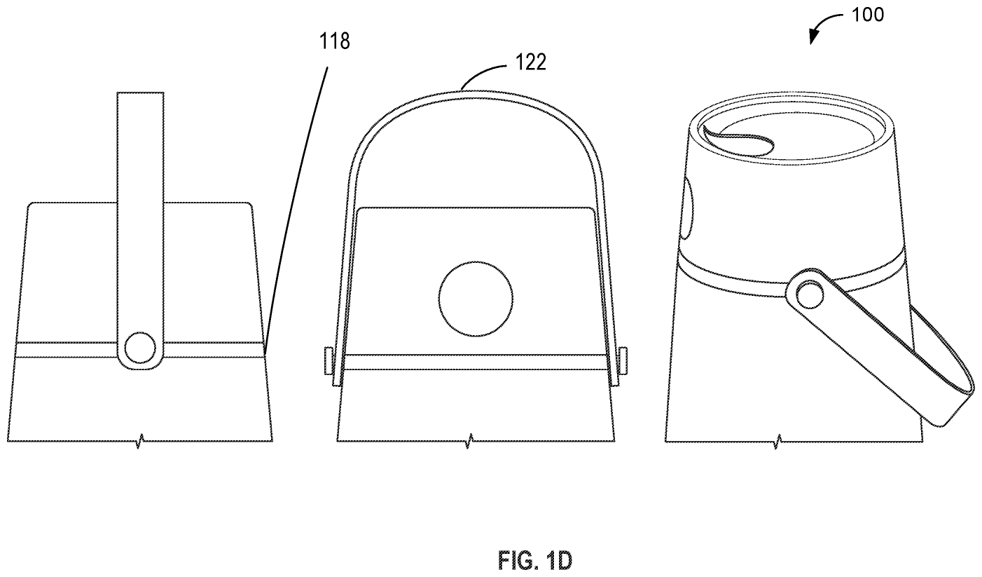

FIGS. 1A-1D show examples of a beverage container. FIG. 1A is an exploded view of some of the key assembled and removable pieces in an example embodiment of a beverage container 100. Beverage container 100 includes lid 102 for sealing in the beverage in a spill proof manner. In some embodiments, beverage container 100 also includes a removable accessory ring 104 for enabling a modularization of container 100 with different accessories. In some embodiments, container 100 also includes a thread pattern 106 that mates with an inner thread pattern in lid 102. In some embodiments, container 100 also includes an inner ring 108 for attaching an inner cannister 110 to sleeve 112. Inner canister 110 holds the fluid. In some embodiments, sleeve 112 functions as an external barrier to prevent damage to inner cannister 110, and also includes several auxiliary functions, such as magnetic lid levitation attachment. FIG. 1A shows just one example of an exploded view of main assembled pieces that all integrate and fit together. Other embodiments may include all, plus new pieces, or just some of the pieces described above.

FIG. 1B shows an example of a beverage container 100 with a simple attachment ring 114 but without an accessory. FIGS. 1C-1D show examples of a beverage container with an accessory. For example, FIG. 1C shows an inner ring with an accessory ring. In some embodiments, ring accessory 118 includes a twisting mechanism to install and remove. FIG. 1C shows a bottom view of accessory ring 118 with the lid removed from the rest of the container. In some embodiments, accessory ring 118 has a turn mechanism for attaching ring 118 to the lid. In some embodiments, container 100 includes an accessory 120, e.g., a handle, installed onto ring 118. In some embodiments, accessory ring 118 is permanently attached to accessory 120. In other embodiments, accessory ring 118 is removably coupled to accessory 120. FIG. 1D shows multiple angles of an example embodiment including a ring accessory 118 with a different accessory 122, e.g. a carry loop.

FIGS. 2A-2B show a close up of a vertical slice view of a beverage container 200. When button 202 is pushed, it changes the directional force of an aperture mechanism, which when changed, allows aperture 208 to be opened, thereby allowing water from the inner canister to flow out from the lid top. FIG. 2A shows the mechanism in a closed position. FIG. 2B shows the mechanism in an open position. In some embodiments, a user pushes in pushbutton 202 horizontally, spring 210 causes a lever arm 204 to move in a downward direction, thereby exposing aperture 208 to fluid in the inner cannister. In some embodiments, lever arm 204 may include a silicon seal 206 at the end of the arm for better sealing of aperture 208.

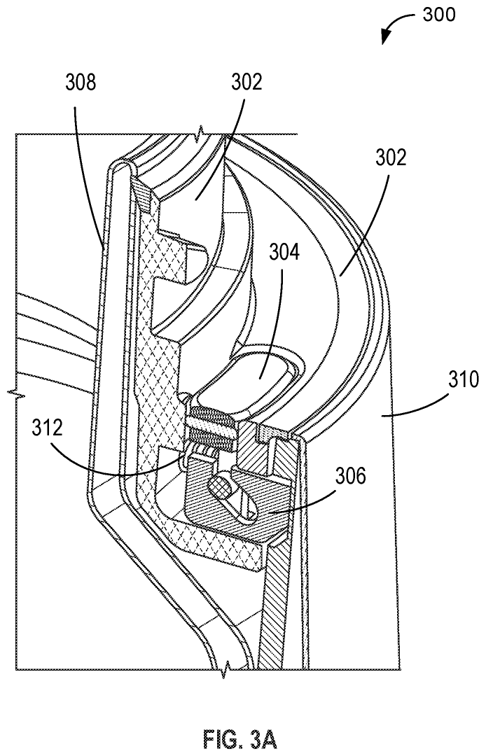

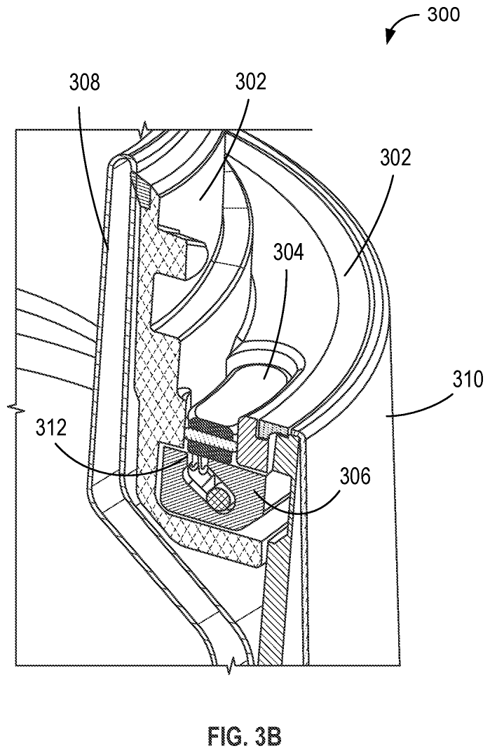

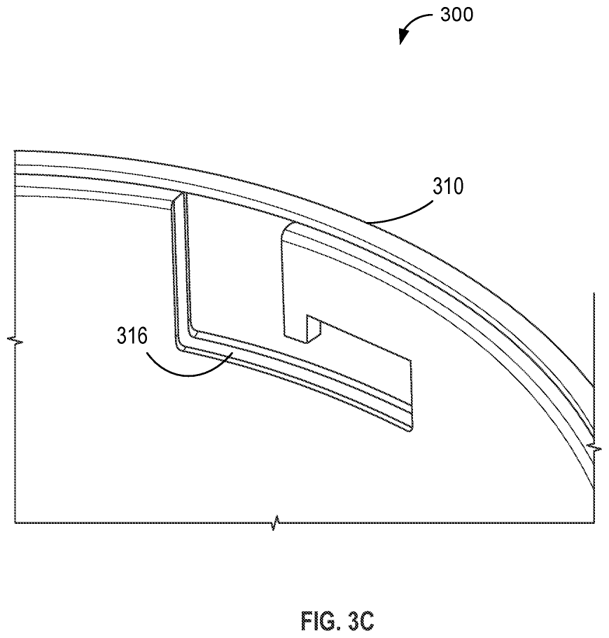

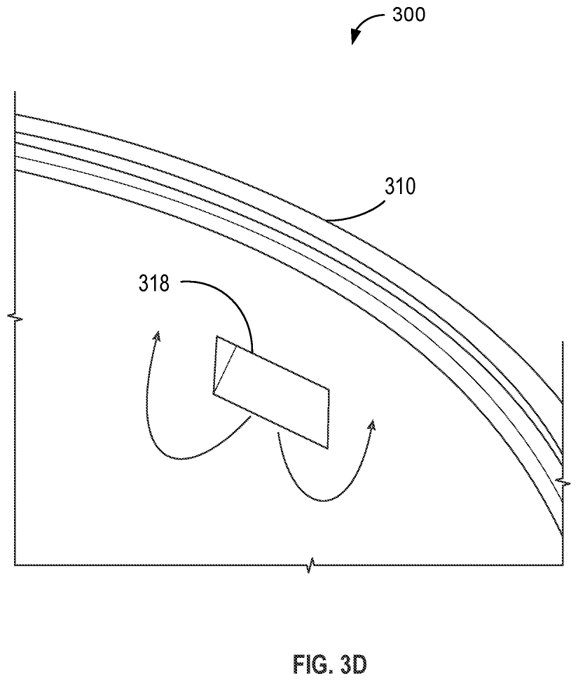

Ease of drinking is not the only advantage offered in the techniques and mechanisms described herein. According to various embodiments, the act of refilling the beverage container is also improved. According to various embodiments, a sleeve is designed to couple, or contain, an inner canister of the beverage container. In some embodiments, the sleeve can be removably coupled to the inner canister, using an attaching mechanism, such as one shown in FIGS. 3A-3B.

FIG. 3A is a cut angle view of a container 300, showing an inner ring 302 with an intentional ring release mechanism 304 that allows a user to apply intentional force when the lid is removed, downward in this case, such that a locking mechanism 306 is actuated. In some embodiments, actuating locking mechanism 306 releases the force that was holding inner cannister 308, along with inner ring 302, to sleeve 310 and preventing inner cannister 308 from being removed accidentally. FIGS. 3A and 3B show just one embodiment of an example intentional ring release mechanism. In such an embodiment, once a release mechanism 304 (e.g., a button) is pushed down, the pushdown motion actuates a spring 312 to move in the planar horizontal position such that a pawl mechanism 306 gets pushed back into the ring release position. In other words, pushing the button down causes a spring to release a locking mechanism in the horizontal position, which then allows the inner ring to be removed upward from the sleeve.

In some embodiments, when the button is pushed down, the pawl disengages with a nook in the sleeve. In some embodiments, the pawl moves left to disengage. By having an area that is only user controlled, the button can only be pressed down by a user and not by any other part of the product. This allows the inner cannister to only be released intentionally by the user. In some embodiments, a spring mechanism is used. In other embodiments, any mechanism that allows for movement of the pawl would suffice. FIG. 3A shows the pushdown mechanism in the locked position. FIG. 3B shows the pushdown mechanism in the unlocked position. In FIG. 3B, once the button is pressed down, the pawl shifts left, and is thereby no longer obstructing the inner sleeve from being vertically removed.

FIG. 3C illustrates a horizontal cut out view showing an alternative embodiment of a nook (or inner ring release mechanism complement) in the sleeve that mates with locking mechanism 306. FIG. 3C showcases an inner view of sleeve 310. In some embodiments, nook 316 is designed as part of sleeve 310, which may lock with a pawl mechanism 306. In some embodiments, sleeve 310 is configured such that an inner ring with a protruding piece, not shown, could be slotted down, turned right, and twisted up in order to be locked in place. In such embodiments, in order to remove the inner ring, the user must then push the ring down, twist left, and then pull up to remove the ring.

FIG. 3D illustrates yet another alternative embodiment of a nook 318, also designed as part of sleeve 310, that mates with a locking mechanism 306. In the example illustrated in FIG. 3D, container 300 shows a nook 318 comprising a sleeve cutout design for an inner ring release mechanism. Nook 318 incorporates anti-rotation functionality. Like the example illustrated in FIG. 3C, the example in FIG. 3D illustrates how a pawl mechanism in the inner ring/inner cannister, e.g., a protrusion, can be slotted inward into sleeve 310 in order to be locked. To release the inner ring/inner cannister, a user simply pushes a pushbutton mechanism and the inner ring comes out vertically because the pawl becomes flush with the rest of the inside surface of sleeve 310. With this example, the inner ring/inner cannister cannot be rotated.

In some embodiments, the sleeve can also contain a strategically placed magnet, which then corresponds to a magnet in the lid that mates to it. In order to refill a completely closed bottle, the user can either use the push button mechanism, which allows one hand refill, or the user can remove the lid entirely, which is much faster than using the single push button opening. However, if the user removes the lid, instead of placing the lid on any random surface, in some embodiments, the user can place the lid and the sleeve together at the point where the magnets are located so the lid attaches to the surface of the sleeve and appears to levitate. This allows for the lid to not come in contact with various surfaces that may not be clean, which is very important during times like a pandemic. In some embodiments, the magnets are configured such that the lid will only attach to the side of the sleeve if the lid is upside down, i.e., the surface of the lid that touches liquid while screwed onto the container is facing up. This can be achieved by orienting the polarity of the magnets and positioning the magnets in such a way that they only attract when in a certain orientation. Having the lid be upside down during levitation provides the added advantage of preventing any residual liquid droplets from dripping onto a surface.

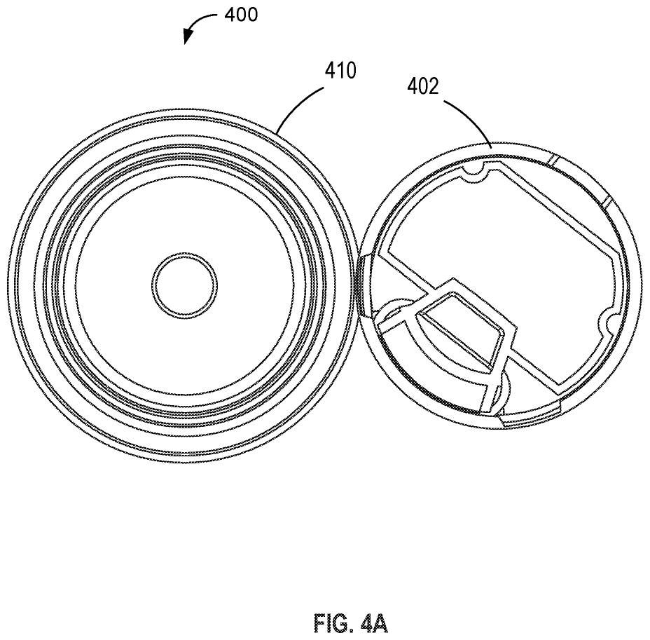

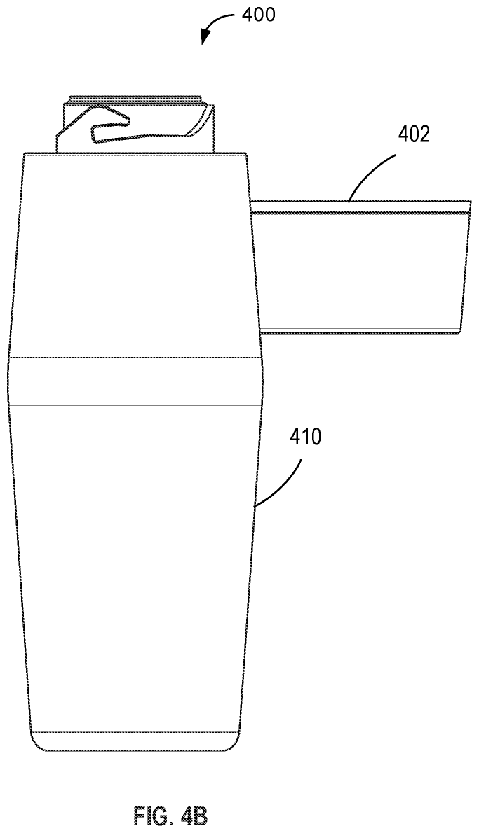

FIG. 4A is a top down view of a beverage container with sleeve coupled with a lid. In the figure, the assembled bottle 400 is on the left, and the lid 402 is on the right. In some embodiments, there is an alignment where magnets in lid 402 are aligned with the magnets in sleeve 410. In some embodiments, there may be one or more places on the sleeve that have magnets for alignment. In some embodiments, magnets can even be placed in a 360 degree fashion (e.g., a ring) anywhere and/or everywhere in the sleeve.

In some embodiments, magnetic steel can be used in place of one of the magnets, either in the sleeve or the lid, as long as the complementary piece in the lid or sleeve is a magnet. FIG. 4B shows a side view of the beverage container 400 and lid 402. FIG. 4D illustrates a side view with a vertical cut of the matching bottle and lid. Although FIG. 4B shows the lid magnetically aligned with magnets in sleeve 410 near the top of container 400, container 400 can be configured to have magnets align at any location along sleeve 410, e.g., the bottom half portion of container 400.

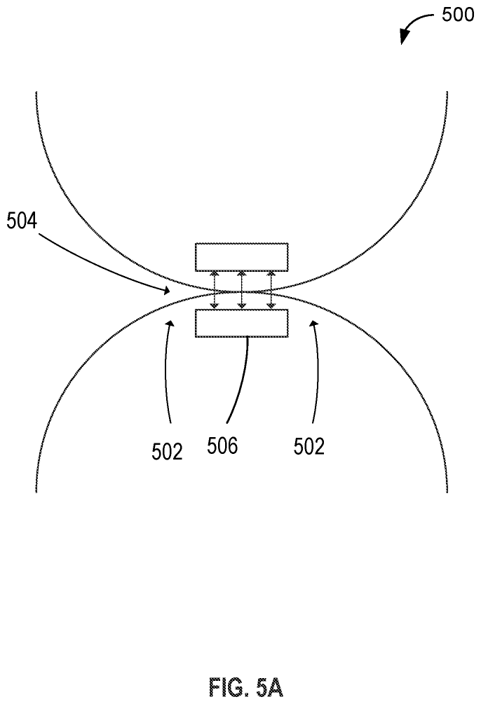

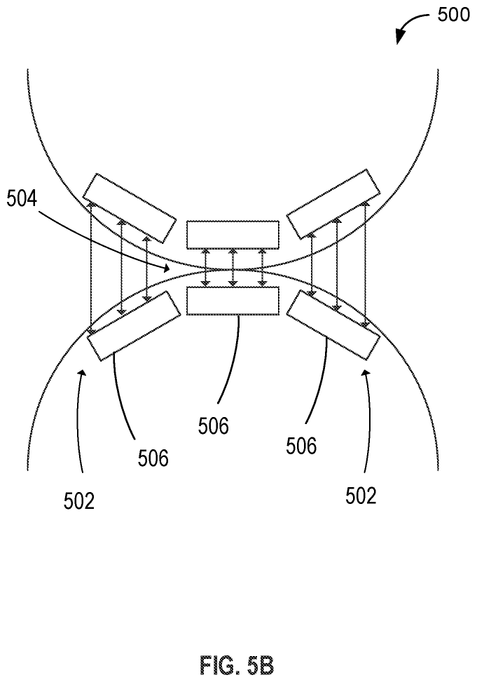

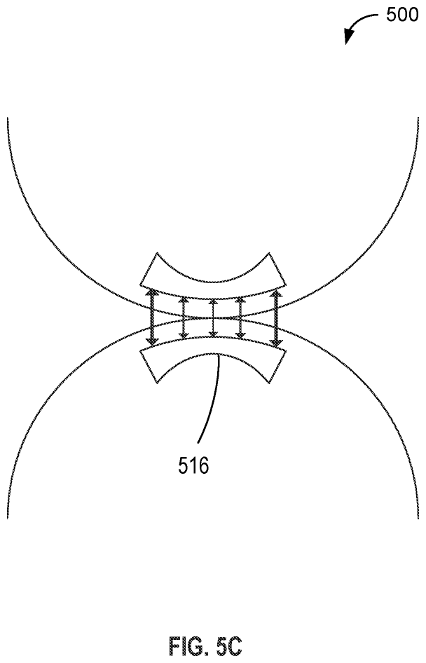

FIG. 5A shows an example embodiment using a single square magnet at the point of coupling. While this embodiment solves the issue of non-uniform magnetic fields, the distance between the magnets at the point of contact is increased as the sleeve and lid curve out. Thus, in such embodiments, the strength of the magnets may need to be increased in order to levitate effectively. In some embodiments, this problem can be solved by using very strong magnets, such as n52. However, such strong magnets will often interfere with any electronics in the vicinity, which may hinder any “smart” functions in the beverage container. Thus, according to various embodiments, more than one magnet can be strategically placed in the sleeve and/or lid to provide extra magnetic strength. In such embodiments, a magnetic array can be used to oppose the force of gravity, which is pushing the lid down. For example, in some embodiments, container 500 can have a first magnet in the lid, a second magnet in the sleeve, and a third magnet oriented below the second magnet in the sleeve, vertically, in order to help the levitation (not shown). In some embodiments, the second magnet is positioned such that it attracts the first magnet in the lid. However, in such embodiments, the third magnet on the bottom of the second magnet may be oriented to have a negative repel force against the first magnet in the lid. Thus, in such embodiments, the third magnet creates a magnetic field that is supporting the bottom of the first magnet to counteract the force of gravity pulling the lid down. Instead of having to increase the magnetic strength, which is an issue because of electronics, the orientation of the magnets in this magnetic array allows the lid to magnetically bind to the sleeve, while keeping the support necessary, without increasing the bulk thickness of the magnets or without needing to increase the magnet strength.

In some embodiments, the magnetic array orientation is not limited to a vertical array. In some embodiments, a horizontally configured (but curved) magnetic array provides an additional advantage because of the curved shape of surface of the sleeve and lid. As shown in FIG. 5A, because of the curvature of the sleeve and lid, the magnetic force may not be as strong on the outer edges 502 of the coupling point 504 as it is at the center of coupling point 504, where the magnets 506 are located. The weakening of this force allows gravity to pull the lid down if the magnets are not strong enough. As previously mentioned, this can be resolved by strengthening the magnets, but this may interfere with electronic function. Thus, another solution can be a magnetic array, as shown in FIG. 5B. FIG. 5B illustrates using a magnetic array 506 along coupling point 504. Although the magnets toward the outer edges 502 have a weaker magnetic attraction force than the magnets at the center of coupling point 504, beverage container 500 can be designed in such a way such that the weaker outside magnetic forces still sufficiently bolster the magnetic attraction force of the magnets located at the center of coupling point 504, which results in a magnetic orientation that is strong enough to hold the lid, while still being safe for electronics.

In some embodiments, instead of using a magnetic array to increase the force of holding the lid, the properties of either the lid magnets or the magnets in the container can be altered. For example, the properties of the magnets can be changed by putting a specific type of pattern of north and south poles on the same side which creates many shorter magnetic fields called near field magnetic flux. This pattern would be precisely created in such a way that it matches the distance between the magnet and a thin magnetic metal. In some embodiments, this pattern of north and south poles on one side increases the force per square inch to a level that will hold up the weight to the desired level without having to increase the magnets size. In some embodiments, the same weight holding strength can be achieved with a smaller magnet paired with magnetic metal as a larger magnet to magnet embodiment.

Yet another solution may be use curved magnets with varying thickness along the curvature. FIG. 5C illustrates an embodiment with curved magnets and a uniform magnetic field. FIG. 5C illustrates a lid and a sleeve with curved magnets 516. Since the curved magnets do not have uniform thickness throughout its shape, the magnetic strength is increases as the magnets get thicker. Therefore, the magnets should be configured in a manner such that the magnets are strongest or thickest at the ends furthest away from the middle. That way, as the magnets curve away from each other, the strength of the magnets is increased. Since the distance increases as the magnetic strength increases, the magnetic field between the two magnets can be substantially uniform along the curvature. In some embodiments, this may be implemented using a single magnet. However, designing a magnet to have increasing thickness along a curvature may be hard to implement using a single magnet. Thus, in some embodiments, an array of magnets can also allow for varying thickness along the “length” of the magnet. In such embodiments, instead of a single curved magnet of varying thickness, the “magnet” is made up of an array of small magnets with varying thickness. The small magnets toward the end of the array may be thicker or stronger than the small magnets in the middle of the array.

According to various embodiments, the magnets are intentionally designed to be located in a sleeve because the inner canister, which is designed to hold the liquid, is often insulated using a double wall vacuum. Typically, magnets cannot be put into a double wall vacuum because of the way double wall vacuums are manufactured. When a vacuum is manufactured, the process includes increasing the temperature within the double wall to 450 degrees Fahrenheit or above, then sealing the space in between the double wall, and letting the temperature cool down to normal temperatures. This heating process essentially makes the vacuum. Magnets typically demagnetize anywhere from 200 degrees Fahrenheit or above. Thus, magnets would lose their magnetic ability during the vacuum heating process. Thus, a separate sleeve, which is designed to go on the outside of the inner canister, can be designed to house the magnet. However, certain embodiments can incorporate magnets into the inner cannister itself after the double wall vacuum process has already been completed. In addition, in some embodiments, the inner cannister does not have a double wall vacuum, and thus, can house the magnets themselves.

According to various embodiments, the sleeve cannot be made of a magnetic material because it interferes with electronics. In some embodiments, the sleeve can be made of steel, but the magnet in the lid would need to be a bit stronger, than with two magnets. In some embodiments, the sleeve is made of plastic, fabric, or even wood. In some embodiments, the sleeve can be made of a neoprene mesh material. Such materials can be used as long as it does not substantially interfere with the magnetic fields emanating from the magnets.

According to various embodiments, one mechanism described herein allows for the separation of the part that holds the liquid, the double wall vacuum piece, from the outer sleeve. This allows the user to change out the sleeve while keeping the same inner canister. However, some designs, such as a press fit design, allow a user to unintentionally remove the sleeve from the inner canister. In a press fit design, if a user pulls on the lid and the bottom, the sleeve can come off unintentionally. In order to prevent this, the sleeve includes an inner ring and an inner ring mechanism, as described above, that all works together such that the user can easily attach and detach the sleeve from the inner canister, but not unintentionally. In some embodiments, in the resting position, the inner canister cannot be pulled out of the sleeve because of a protruding edge being pushed out via a spring mechanism. The protruding edge catches on the ledge ring when the user attempts to remove the inner canister from the sleeve without first pressing on the button that controls the actuator. However, once the user presses a button on either side of the ring, the actuator goes down, moves the mechanism with the spring, and makes the protrusion flush with the sleeve, thereby allowing the inner canister to be able to be pulled out. In some embodiments, the spring actuates at a 45 degree angle when the button is not being pressed down. However, when the button is pressed down, the spring pulls back, allowing the user to pull the inner canister straight up.

The mechanisms described above correspond to putting an inner cannister into a sleeve, as well as removing the inner cannister from the sleeve. These mechanisms provide for various advantages over standard screw-on technology. For example, if the inner cannister to sleeve coupling mechanism was a standard screw-on mechanism, and then the lid to inner cannister coupling was also a screw-on mechanism, then the user can accidentally unscrew the sleeve when trying to unscrew the lid (if the threading pattern is in the same direction) or trying to screw on the lid (if the threading pattern is in the opposite direction). Having the sleeve and inner cannister be coupled using a push button mechanism described above, prevents this unwanted phenomenon.

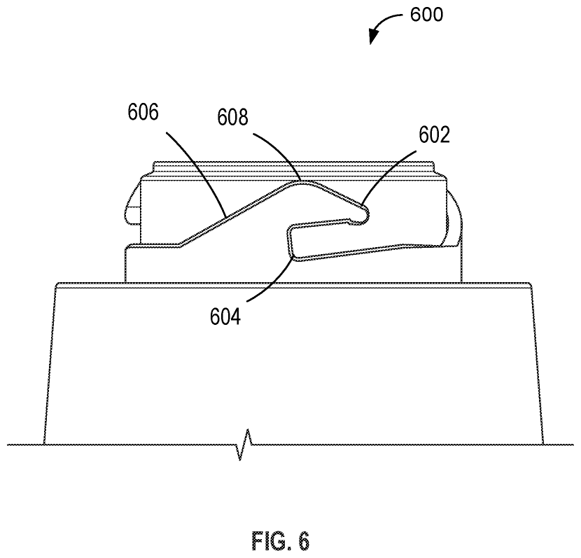

In addition, improved mechanisms for putting on the lid itself are described below. FIG. 6 shows an improved threading pattern with multiple advantageous over a standard screw-in mechanism. In a normal threading pattern, a user has to screw the lid more than 45 degrees, and sometimes the user never knows if it is fully closed. In many instances, a normal threading pattern does not give a positive stop, which can potentially cause a user to continue screwing the lid unnecessarily. This can often lead to tightening the lid too tight, thereby putting a lot of pressure on the silicone ring and making the lid very hard to take off. In addition, combined with the characteristics of beverages, when a hot beverage is put into a closed container, pressure builds up and puts more pressure to release it, making the lid extremely difficult to remove. Thus, in some embodiments of the present disclosure, techniques and mechanisms of the present disclosure include adding a threading pattern with a positive stop, to prevent over tightening.

FIG. 6 illustrates an example novel threading pattern with a positive stop. The threading pattern on the top of inner canister 600 resembles a wave pattern with a ledge 602 and a nook 604 underneath the ledge. The example embodiment shown in FIG. 6 shows a novel threading pattern comprising three or more ramps 606. In some embodiments, this thread pattern could be made on the inner canister. In other embodiments, this threading pattern can be made on the sleeve itself. In some embodiments, ramps 606 allow unidirectional locking of the lid onto container 600 such that a user can place the lid (not shown) at any point along the thread pattern and still lock the lid by either twisting to the left or twisting slightly right and then left.

In some embodiments, ramp 606 has an upward slope, then a small peak 608, then a downward slope followed by a drop-off ledge 602. In some embodiments, underneath drop off ledge 602 is an inner cut “nook” 604. This nook is where a matching piece of material on the lid, a.k.a. a nook complement, will hit a hard stop (while the user twists left), thereby preventing the lid from being able to be twisted any further in the left direction. In some embodiments, the downward slope allows the user to twist slightly right, if the nook complement in the lid is sitting on top of peak 608, and slide down the downward slope into the entrance of nook 604. Thus, when the lid is placed anywhere, including on peak 608, the user can simply twist (with less than a 45 degree turn) either right, then left, or just left, until it hits the inside nook 604.

In some embodiments, this pattern allows anyone to put on the lid at any point by simply pressing down and turning less than 45 degrees, with a positive stop. In some embodiments, on the lid there is an equivalent but complementary protruding out design that goes underneath ledge 602, fits into nook 604, and stops. In some embodiments, the thread pattern has a left twist lock-in design. In other embodiments, the thread pattern has a right twist lock-in design. According to various embodiments, the new thread pattern is designed to lock, with either a right or left twist, with less than a 45 degree turn.

In some embodiments, the wave thread pattern is coupled with a silicone ring to provide a spill proof design. In such embodiments, the quarter turn lock (or rather less than quarter turn lock) in combination with the material of the silicone ring, and the geometry of the silicone ring, allows the lid to be properly sealed (e.g., leak proof).

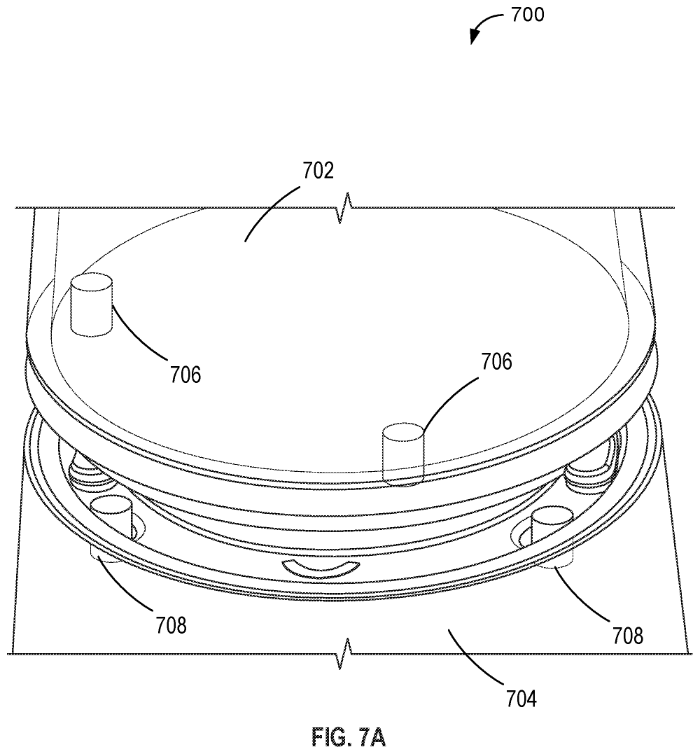

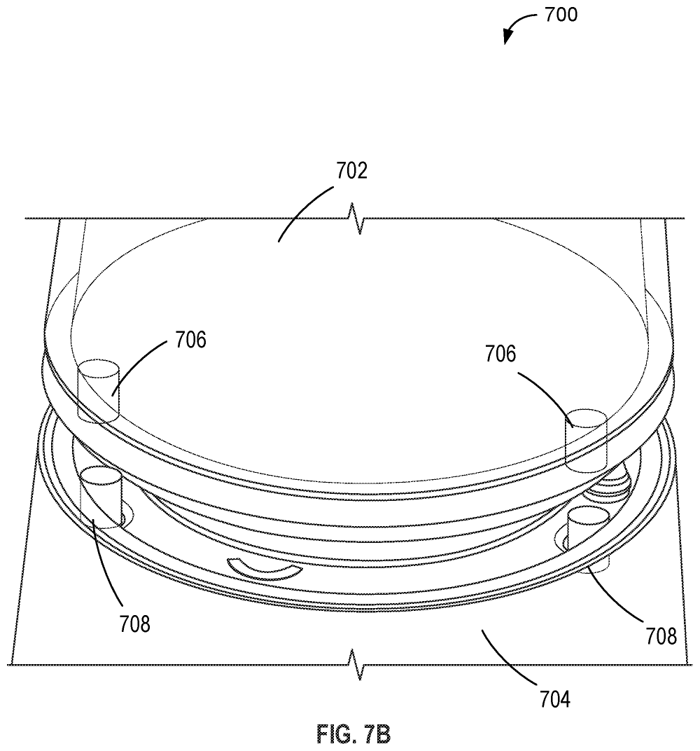

In some embodiments, the lid locking mechanism also includes magnets near the top surface of the inner ring (or sleeve) and near the bottom surface of the lid in order to facilitate screwing on the lid. FIGS. 7A-7B show a transparent view of a lid 702 and an assembled inner canister/inner ring/sleeve 704 of beverage container 700. In FIGS. 7A-7B, both lid 702 and inner canister/inner ring/sleeve include magnets internally near the coupling point. FIG. 7A shows lid magnets 706 in misalignment with bottom magnets 708. FIG. 7B illustrates where the magnets are aligned. In some embodiments, the magnets are placed such that the magnetic attractive/repulsive forces help “guide” the user when twisting the lid onto the inner canister/inner ring/sleeve.

In some embodiments, the sealed position is actually not magnetically aligned. This is because the magnets act only as a guide to improve user experience when closing the lid. The magnets guide the use to the position shown in FIG. 7B, and then the user can simply snap the lid sealed by twisting to the left. The suction created by depressing the silicone seal keeps the lid in place. In addition, the magnetic guides also help the user unseal the lid by adding attractive force in the right direction away from the nook. However, in some embodiments, the magnets have to be designed such that the attractive force is not nearly strong enough to displace the lid seal on its own. Thus, the magnets create a repeatable align-to-sealed pattern to assist with opening and closing the lid.

In such embodiments, the magnets help facilitate the closing process. In some embodiments, the placement of the magnets is important. For example, a magnet at the very top of the “wave” would require a user to be pushing against the force. If instead, the magnet is placed off center from the top of the “wave,” the magnets will then pull themselves together into the right position, as a sort of magnetic guide. In some embodiments, the magnets are located in the lid and the ring, but not the thread itself. In some embodiments, the magnet strength in the lid closing mechanism is not very strong because otherwise it would be hard to take off. In some embodiments, the magnetic guide can include the ring or the sleeve. In some embodiments, the ring mechanism is located in the sleeve and is removable. In other embodiments, the ring is in the sleeve and is not removable.

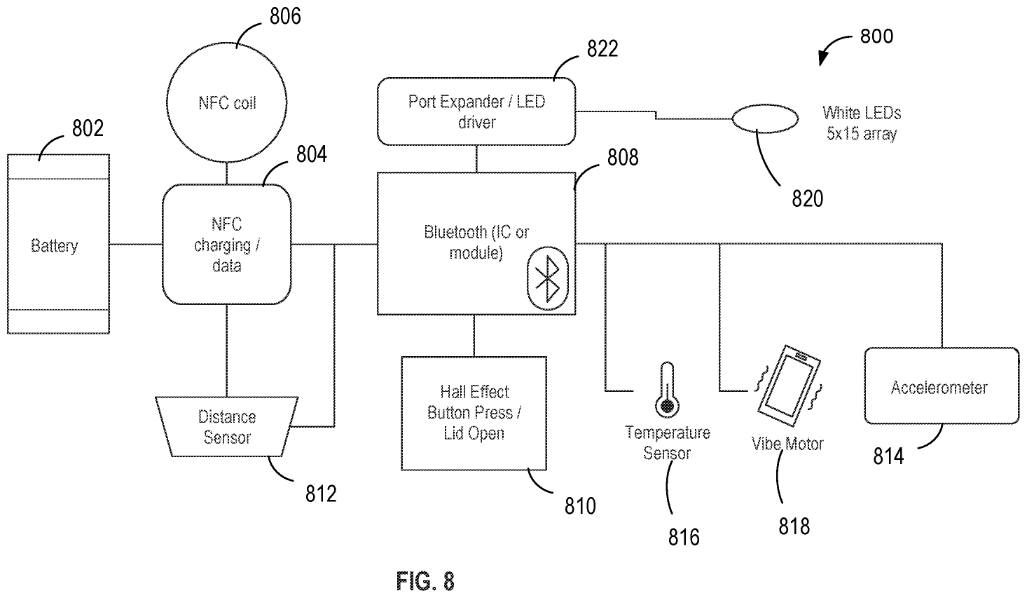

As mentioned above, techniques and mechanisms of the present disclosure describe certain “smart” features in the beverage container. FIG. 8 is a block diagram showing different electronic smart features of a beverage container. FIG. 8 is a diagram denoting components of an electronic system 800 that can be placed in the lid, inner cannister, inner ring, or sleeve, in order to measure quantities and characteristics about the fluid inside the beverage container. The characteristics include data such as distance and temperature. In some embodiments, distance can be used to determine the approximate level of fluid left in the container, which can be used to calculate how much fluid has been consumed in between changes of distance. In some embodiments, system 800 includes a battery 802, an NFC chip 804, and an NFC coil 806 to allow the container to charge and pair with other electronic devices. In some embodiments, NFC chip 804 can send data and power to another NFC receiver. In other words, in some embodiments the beverage container can be used to wireless charge electronic devices, such as a mobile phone. In some embodiments, system 800 can include a Bluetooth module 808 to allow the container to connect to other Bluetooth devices, such as smartphones, as well as leveraging a pushbuttton mechanism 810 in order a characteristics reading on/off. In other words, pushbutton mechanism 810 can be used to determine when the reading of distance, via distance sensor 812, should be turned on, because the user has to push button 810, and hold it, in order for the beverage to be consumed. In such embodiments, pushing button 810 then intelligently activates Bluetooth module 808 to take measurements, and releasing button 810 deactivates the Bluetooth module. That way, power can be saved for use only when necessary, thereby extending battery life. This design saves battery because the container does not have to constantly measure distance metrics. Instead, the container only needs to measure distance metrics when the user is actively consuming the beverage. In some embodiments, system 800 includes an accelerometer 814 to pair with pushbutton 810 to inform the container that it is in the drinking motion. In some embodiments, once button 810 is pushed and then subsequently released, the electronics are configured to do a reading and calculation of how much liquid was consumed (if the accelerometer reads a calibrated accelerometer state, e.g., sitting on a flat surface), as well as other data points, and then go back into sleep mode.

In some embodiments, system 800 includes a temperature senso 816. In some embodiments, temperature sensor 816 can be used in combination with a vibration motor 818 such that if a program from a Bluetooth connected device tells system 800 that such the user does not want to drink any beverages over a “too hot to consume temperature,” which can be user defined, then the system will notify the user (via vibration motor 818) that the beverage is either too hot to consume, or ready to consume. In other words, a user can set a temperature limit that is used to prevent the user from burning their mouth on beverages that they consider to be too hot. For example, if the user does not want to drink any beverage above 180 degrees F., then the “too hot to consume” temperature can be set to 180 degrees. If the user then reaches for the beverage container, the beverage container takes the temperature of the liquid using the temperature sensor, and if the temperature is over 180 degrees, the controller/processor will send a signal to vibration motor 818 to vibrate, thereby providing physical feedback to the user, when the user attempts to drink the beverage (e.g., the user presses the push button mechanism). The vibration serves as a notification that the beverage is still too hot to consume. In some embodiments, the controller/processor (not shown) is connected in some way to all elements shown in FIG. 8.

In some embodiments, the components include an LED display 820. The example in FIG. 8 shows a 5×15 array of LEDs 820 that can communicate information to the user using white LEDs. In some embodiments, a port expander 822 serves as the LED driver. In some embodiments, the LED display can be configured to display alphanumeric characters to inform the user of different data and information. For example, the information displayed can be any one of: 1) a hydration status to tell the number of ounces, 2) a notification to tell users when to drink, 3) reminders that the beverage is of a temperature that is drinkable, 4) the actual temperature of the beverage, 5) the battery status, etc. In some embodiments, the LED display is a dot projector.

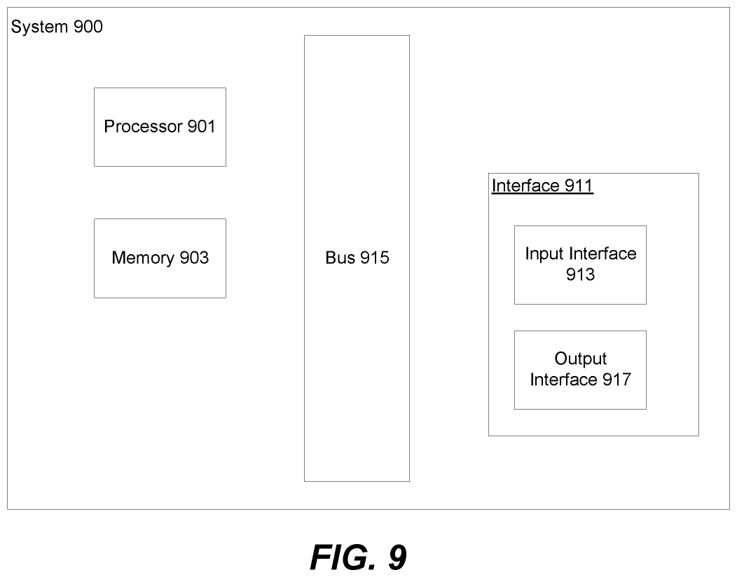

With reference to FIG. 9, shown is a particular example of an electronics system capable of implementing various processes described in the present disclosure. For instance, the system 900 can be used to provide smart lids and beverage containers according to various embodiments described above. According to particular example embodiments, a system 900 suitable for implementing particular embodiments of the present disclosure includes a processor 901, a memory 903, an interface 911, and a bus 915 (e.g., a PCI bus). The interface 911 may include separate input interface 913 and output interface 917, or may be a unified interface supporting both operations. When acting under the control of appropriate software or firmware, the processor 901 is responsible for such tasks such as optimization. Various specially configured devices can also be used in place of a processor 901 or in addition to processor 901. The complete implementation can also be done in custom hardware. The interface 911 is typically configured to send and receive data packets or data segments over a network. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 900 uses memory 903 to store data and program instructions and maintain a local side cache. The program instructions may control the operation of an operating system and/or one or more applications, for example. The memory or memories may also be configured to store received metadata and batch requested metadata.

Because such information and program instructions may be employed to implement the systems/methods described herein, the present disclosure relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present disclosure.

While the present disclosure has been particularly shown and described with reference to specific embodiments thereof, it will be understood by those skilled in the art that changes in the form and details of the disclosed embodiments may be made without departing from the spirit or scope of the disclosure. It is therefore intended that the disclosure be interpreted to include all variations and equivalents that fall within the true spirit and scope of the present disclosure.

What is claimed is:

1. A beverage container, comprising:
an inner canister including a base coupled to a wall including a first wall region and a second wall region adjoining the first wall region, the base and the wall forming an interior region for containing a beverage;
a lid configured to be removably coupled to the inner canister via a screw mechanism, the lid including one or more lid magnets; and
an outer sleeve configured to be removably coupled to the inner canister, the outer sleeve including one or more sleeve magnets,
wherein the lids magnets are configured to magnetically couple with the sleeve magnets such that the lid is magnetically stuck to the sleeve and appears to levitate adjacent to the sleeve when the lid magnets come within close proximity to the sleeve magnets.

2. The beverage container of claim 1, wherein the magnets are curved shaped to provide uniform magnetic fields.

3. The beverage container of claim 1, wherein the lid magnets are configured such that the lid magnets will only stick to the sleeve magnets when the lid is upside down.

4. The beverage container of claim 1, wherein the screw mechanism is a wave pattern.

5. The beverage container of claim 1, wherein the screw mechanism includes magnetic guides.

6. The beverage container of claim 1, wherein the lid includes a horizontal push button to horizontally open a lid opening cover.

7. The beverage container of claim 1, wherein the lid includes a processor for implementing various smart functions.

8. The beverage container of claim 1, wherein the sleeve includes a processor for implementing various smart functions.

9. The beverage container of claim 1, wherein the inner canister includes a double vacuum seal between the first wall region and the second wall region.

10. The beverage container of claim 1, wherein the inner canister can be removed from the sleeve via a single push button release mechanism.

11. A system, comprising:
an inner canister including a base coupled to a wall including a first wall region and a second wall region adjoining the first wall region, the base and the wall forming an interior region for containing a beverage;
a lid configured to be removably coupled to the inner canister via a screw mechanism, the lid including one or more lid magnets; and
an outer sleeve configured to be removably coupled to the inner canister, the outer sleeve including one or more sleeve magnets,
wherein the lids magnets are configured to magnetically couple with the sleeve magnets such that the lid is magnetically stuck to the sleeve and appears to levitate adjacent to the sleeve when the lid magnets come within close proximity to the sleeve magnets.

12. The system of claim 11, wherein the magnets are curved shaped to provide uniform magnetic fields.

13. The system of claim 11, wherein the lid magnets are configured such that the lid magnets will only stick to the sleeve magnets when the lid is upside down.

14. The system of claim 11, wherein the screw mechanism is a wave pattern.

15. The system of claim 11, wherein the screw mechanism includes magnetic guides.

16. The system of claim 11, wherein the lid includes a horizontal push button to horizontally open a lid opening cover.

17. The system of claim 11, wherein the lid includes a processor for implementing various smart functions.

18. The system of claim 11, wherein the sleeve includes a processor for implementing various smart functions.

19. The system of claim 11, wherein the inner canister includes a double vacuum seal between the first wall region and the second wall region.

20. The system of claim 11, wherein the inner canister can be removed from the sleeve via a single push button release mechanism.
